(19) United States
(12) Patent Application Publication
(10) Pub. No.: US 2026/0118807 A1
(43) Pub. Date: Apr. 30, 2026

(54) IMAGE FORMING APPARATUS, IMAGE FORMING SYSTEM, AND STORAGE MEDIUM

(71) Applicant: Konica Minolta, Inc., Tokyo (JP)

(72) Inventors: Akimasa Ishikawa, Tokyo (JP); Junichi Masuda, Toyokawa-shi (JP); Satoshi Ogata, Tokyo (JP); Daichi Suzuki, Tokyo (JP); Hiroyuki Yoshikawa, Tokyo (JP)

(73) Assignee: Konica Minolta, Inc., Tokyo (JP)

(21) Appl. No.: 19/371,469

(22) Filed: Oct. 28, 2025

(30) Foreign Application Priority Data
Oct. 29, 2024 (JP) 2024189635

(51) Int. Cl. G03G 15/00; G03G 21/20

(52) U.S. Cl. CPC G03G 15/5029; G03G 21/203; G03G 2215/00489; G03G 2215/00776

(57) ABSTRACT

An image forming apparatus includes: an image former that forms and outputs an image on a sheet; and a hardware processor that causes the image former to output a sample image on the sheet. The hardware processor changes an image formation condition while the image former is outputting the sample image, based on at least one of sheet characteristic information and environment information.

### CROSS-REFERENCE TO RELATED APPLICATIONS

The entire disclosure of Japanese Patent Application No. 2024-189635 filed on Oct. 29, 2024, is incorporated herein by reference in its entirety.

### BACKGROUND OF THE INVENTION

### Technical Field

The present disclosure relates to an image forming apparatus, an image forming system, and a storage medium.

### Description of Related Art

A conventional image forming apparatus has various image quality adjustment functions to meet the demands of users for a high print quality.

For example. Japanese Unexamined Patent Publication No. 2012-163724 describes an image forming apparatus that creates multiple sets of printing parameter conditions related to image quality, based on image data of input images; and outputs multiple sample images, based on the created sets of printing parameter conditions. When a user selects a sample image from the multiple sample images, the image forming apparatus determines the printing parameter condition corresponding to the selected sample image to be a reference condition, forms an output target image on a recording medium based on the determined reference condition, and outputs the medium.

### SUMMARY OF THE INVENTION

Image properties vary according not only to image data but also to the characteristics of sheets used for output and the environment. However, the technique described in JP2012-163724A does not consider the characteristics of sheets used for output or the environment in creating the printing parameter conditions for forming sample images. When sample images are output under uniform image formation conditions without considering the characteristics of sheets used for output or the environment, the output sample images may have image defects, such as fog or white spots, and may be inappropriate. In such a case, the user is provided with less options of sample images and is not allowed to select an optimum sample image. As a result, the set image formation conditions may not meet the user's demand.

An object of the present disclosure is to make it possible to output appropriate sample images regardless of the sheet characteristic or the environment.

To achieve at least one of the abovementioned objects, according to an aspect of the present invention, an image forming apparatus reflecting one aspect of the present invention includes: an image former that forms and outputs an image on a sheet; and a hardware processor that causes the image former to output a sample image on the sheet; wherein the hardware processor changes an image formation condition while the image former is outputting the sample image, based on at least one of sheet characteristic information and environment information.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming system according to a present embodiment;

FIG. 2 is a block diagram illustrating a main functional configuration of the image forming system according to the present embodiment:

FIG. 3 shows an example of a transfer current table when sheet characteristic information is a sheet type:

FIG. 4 shows an example of the transfer current table when the sheet characteristic information is information on multiple items obtained by a media sensor:

FIG. 5 is a flowchart showing a flow of a sample image outputting process to be executed by a controller of the image forming apparatus; and

FIG. 6 shows an example of a fixing temperature table when the sheet characteristic information is a sheet type.

### DETAILED DESCRIPTION

Hereinafter, an embodiment of the present disclosure will be described with reference to the drawings. However, the scope of the present disclosure is not limited to the disclosed embodiment.

### (1. Configuration of Image Forming System)

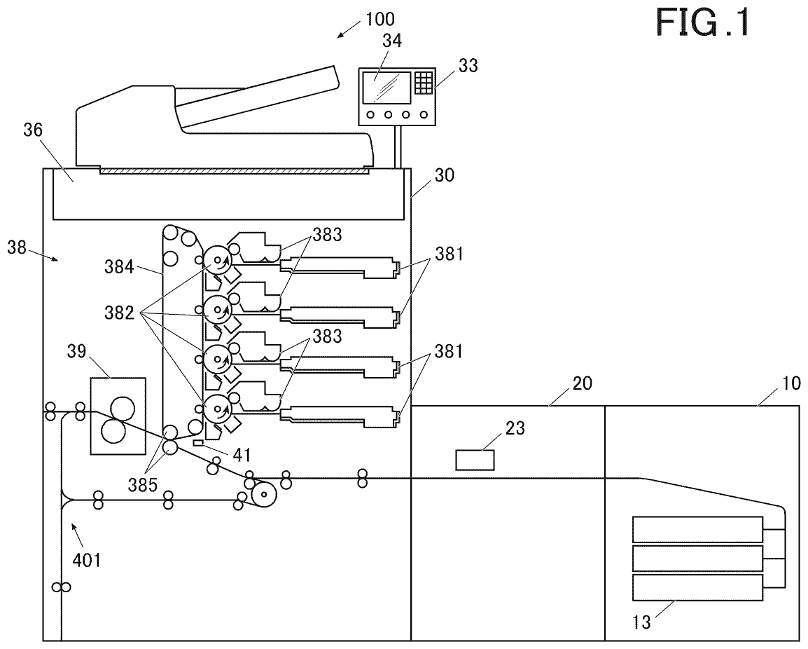

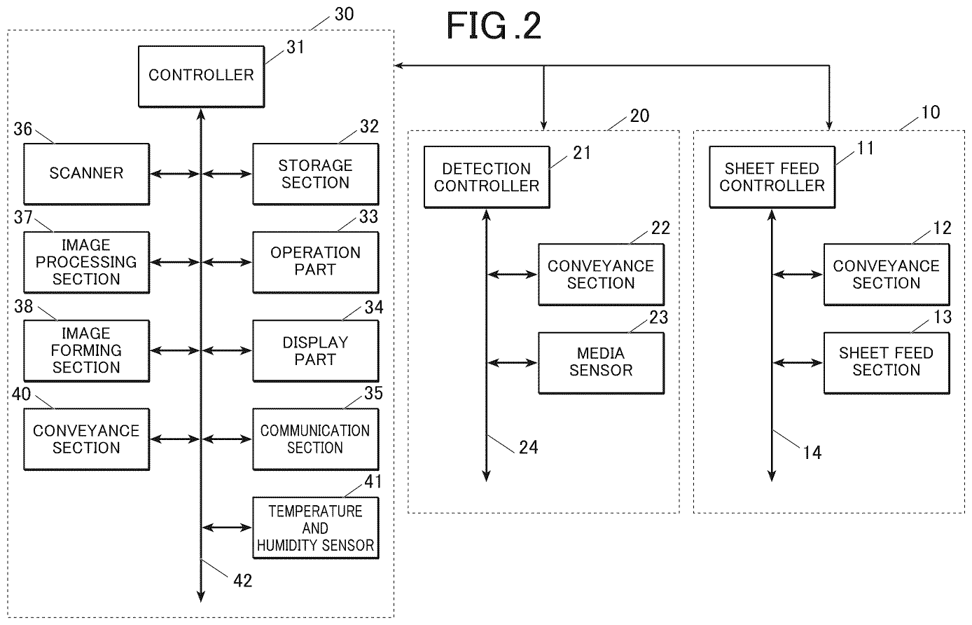

FIG. 1 is a diagram illustrating a schematic configuration of an image forming system 100 according to the present embodiment. FIG. 2 is a block diagram illustrating a functional configuration of the image forming system 100.

The image forming system 100 includes a sheet feed device 10, a detection device 20, and an image forming apparatus 30. In the image forming system 100, the sheet feed device 10, the detection device 20, and the image forming apparatus 30 are disposed in this order from the upstream of a sheet conveyance direction. The sheet feed device 10, the detection device 20, and the image forming apparatus 30 are connected to each other.

### (1-1. Configuration of Sheet Feed Device)

The sheet feed device 10 includes a sheet feed controller 11, a conveyance section 12, and a sheet feed section 13.

The sheet feed controller 11 is connected to the conveyance section 12 and the sheet feed section 13 via a bus 14.

The sheet feed controller 11 includes a central processing unit (CPU), a read only memory (ROM), and a random access memory (RAM). The CPU of the sheet feed controller 11 reads a program stored in the ROM, loads the program in the RAM, and centrally controls each component of the sheet feed device 10 in accordance with the developed program. For example, the sheet feed controller 11 feeds a sheet from one of sheet feed trays of the sheet feed section 13 and conveys the sheet to the detection device 20 with the conveyance section 12 under the control of a controller 31 (hardware processor) of the image forming apparatus 30.

The conveyance section 12 conveys the sheet on a conveyance route that connects the sheet feed section 13 to the detection device 20.

The sheet feed section 13 includes sheet feed trays each storing sheets of a predetermined sheet type and size.

### (1-2. Configuration of Detection Device)

The detection device 20 is provided at the upstream side of the image forming apparatus 30 in the sheet conveyance direction and detects the sheet conveyed from the sheet feed device 10.

The detection device 20 includes a detection controller 21, a conveyance section 22, and a media sensor 23.

The detection controller 21 is connected to the conveyance section 22 and the media sensor 23 via a bus 24.

The detection controller 21 includes a CPU, a ROM, and a RAM. The CPU of the detection controller 21 reads a program stored in the ROM, loads the program in the RAM, and centrally controls each component of the detection device 20 in accordance with the loaded program. For example, under the control of the controller 31 of the image forming apparatus 30, the detection controller 21 causes the media sensor 23 to detect the sheet conveyed from the sheet feed device 10. Next, the detection controller 21 outputs sheet characteristic information that is the detection result by the media sensor 23 to the controller 31 of the image forming apparatus 30. The detection controller 21 also causes the conveyance section 22 to convey the sheet to the image forming apparatus 30.

The conveyance section 22 consists of multiple pairs of rollers and conveys the sheet conveyed from the sheet feed device 10 to the image forming apparatus 30 via the media sensor 23.

The media sensor 23 is provided on (above) the conveyance route in the upstream of the image forming section 38 (image former) of the image forming apparatus 30 in a sheet conveyance direction. The image forming section 38 is described later. The media sensor 23 detects characteristics of the conveyed sheet, obtains sheet characteristic information, and outputs the sheet characteristic information to the detection controller 21. The characteristics of the sheet detected by the media sensor 23 include, for example, sheet thickness, basis weight, moisture percentage, stiffness, smoothness, and resistance.

### (1-3. Configuration of Image Forming Apparatus)

The image forming apparatus 30 forms an image on a sheet by the electrophotographic method, based on image data of a job. Image data of a job is obtained by reading an image of a document or obtained from an external device (not illustrated).

The image forming apparatus 30 includes the controller 31, a storage section 32, an operation part 33, a display part 34, a communication section 35, a scanner 36, an image processing section 37, an image forming section 38, a conveyance section 40, and a temperature and humidity sensor 41.

The controller 31 is connected to the storage section 32, the operation part 33, the display part 34, the communication section 35, the scanner 36, the image processing section 37, the image forming section 38, the conveyance section 40, and the temperature and humidity sensor 41 via a bus 42.

The controller 31 includes a CPU, a ROM, and a RAM. The CPU of the controller 31 reads a program stored in the ROM, loads the program in the RAM, and centrally controls each component of the image forming apparatus 30 in accordance with the loaded program.

For example, the controller 31 causes the storage section 32 to store image data of a job received by the communication section 35 or image data of a job obtained by the scanner 36, causes the image processing section 37 to perform predetermined image processing on the image data, and causes the storage section 32 to store the image data. The controller 31 also causes the conveyance section 40 to convey a sheet and causes the image forming section 38 to form an image on the sheet, based on the image data stored in the storage section 32.

The controller 31 also outputs multiple sample images under different image formation conditions by executing the sample image outputting process (described later) and, based on the use's selection of an sample image, determines an image formation condition for forming an image on the sheet, based on the job. The sample image is an image formed and output on a sheet as a sample of an image output by the image forming apparatus 30. In the 40) sample image outputting process, the controller 31 changes the image formation conditions while outputting sample images (in the middle of outputting the sample images), based on the sheet characteristic information and environment information. That is, the controller 31 changes the image formation conditions to output multiple sample images. The sample images output under different image formation conditions may be output on different sheets or on one sheet.

In the present embodiment, transfer conditions (transfer current) are changed as the image formation conditions during output of sample images, as an example.

The storage section 32 includes a semiconductor memory, such as a DRAM or an HDD. The storage section 32 stores image data of jobs obtained by the scanner 36 and image data of jobs input from outside via the 5 communication section 35. These image data may be stored in the RAM of the controller 31.

The storage section 32 also stores various kinds of data and setting information required for executing the program. For example, the storage section 32 stores a transfer current table 321 and a transfer current table 322. The transfer current table 321 and the transfer current table 322 store (i) combinations of sheet characteristic information and environment information and (ii) transfer currents for outputting sample images (samples 1 to 5) under conditions corresponding to the respective combinations. These (i) and (ii) are stored in association with each other. Note that each transfer current in the transfer current tables 321 and 322 represents the amount of change from a default transfer current.

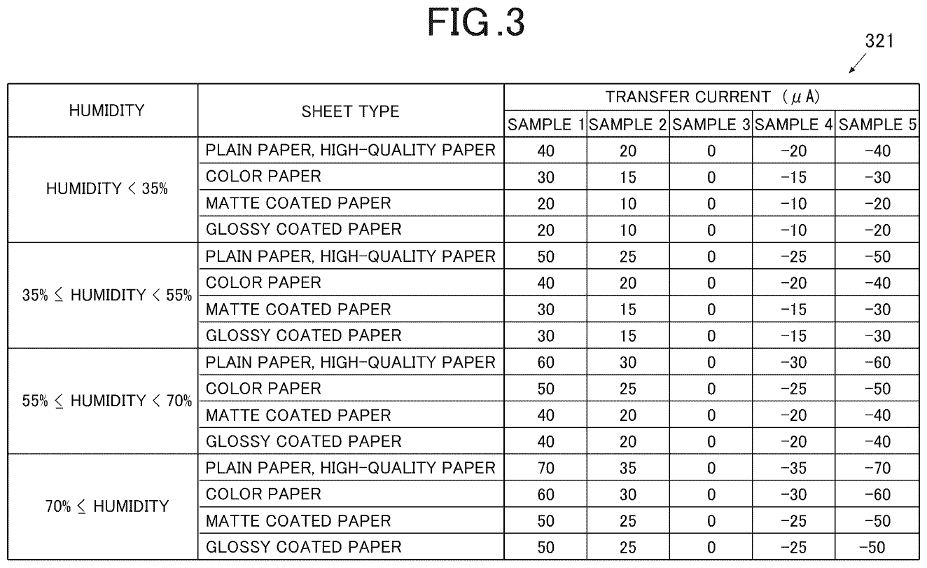

FIG. 3 shows an example of how the data of the transfer current table 321 is stored. The transfer current table 321 shown in FIG. 3 as an example includes: paper types as the sheet characteristic information; humidity as the environment information; and transfer currents as the image formation conditions for outputting sample images. The transfer current table 321 is created, based on the experimentally obtained ranges of the transfer currents that do not cause image defects under conditions consisting of combinations of the sheet characteristic information and the environment information. That is, in the transfer current table 321, the range of transfer current that does not cause image defects under each condition is determined to be the range of transfer current in outputting the sample images (the range from the minimum value to the maximum value of transfer current in outputting the sample images). Further, in the transfer current table 321, a transfer current for each sample image is determined by calculating an interval between transfer currents in outputting sample images (a changing amount between transfer currents for the respective sample images), based on the determined range and the number of sample images.

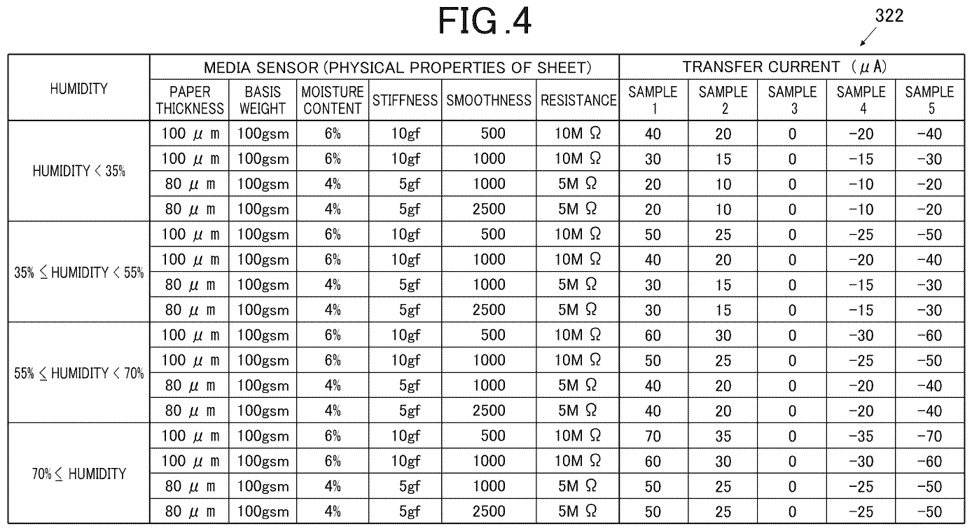

FIG. 4 shows an example of how the data of the transfer current table 322 is stored. The transfer current table 322 shown in FIG. 4 as an example includes: information on multiple items obtained by the media sensor 23 as the sheet characteristic information; humidity as the environment information; and transfer currents as the image formation conditions in outputting sample images. Similarly to the transfer current table 321, the transfer current table 322 is created, based on the experimentally obtained ranges of the transfer currents that do not cause image defects under conditions consisting of combinations of the sheet characteristic information and the environment information. That is, in the transfer current table 322, the range of transfer currents that does not cause image defects under each condition is determined to be the range of transfer currents in outputting the sample images (the range of transfer currents from the minimum value to the maximum value in outputting the sample images). Further, in the transfer current table 322, a transfer current for each sample image is determined by calculating an interval between transfer currents in outputting sample images, based on the determined range and the number of sample images.

In FIG. 4, in each humidity, the sheet characteristic information in the first row corresponds to plain paper and high-quality paper; the sheet characteristic information in the second row corresponds to color paper; the sheet characteristic information in the third row corresponds to coated paper (matte coat); and the sheet characteristic information in the fourth row corresponds to coated paper (gloss coat).

FIG. 3 and FIG. 4 show humidity information as an example the environment information. Temperature information may also be added to the environment information. For another example, only the temperature information may be used as the environment information.

The operation part 33 includes input devices, such as operation keys and a touch screen overlaid on the screen of the display part 34. The operation part 33 converts input operations made on these input devices by the user into operation signals and outputs the operation signals to the controller 31. The operation part 33 functions as an input receiver.

The display part 34 includes a display device, such as a liquid crystal display (LCD), and displays various contents, such as a state of the image forming system 100 and an operation screen indicating contents of input operations on the touch screen.

The communication section 35 transmits and receives data to and from an external device, such as an external computer or another image forming apparatus.

The scanner 36 reads an image formed on a sheet, generates image data including single-color image data for each of color components of R (red), G (green), and B (blue), and stores the image data in the storage section 32.

The image processing section 37 includes, for example, a rasterization processing section, a color conversion section, a gradation correction section, and a halftone processing section. The image processing section 37 performs various kinds of image processing on image data stored in the storage section 32 and stores the processed image data in the storage section 32.

The image forming section 38 forms an image on a sheet, based on the image data stored in the storage section 32. The image forming section 38 includes four sets of an exposure section 381, a photosensitive drum 382, and a developing section 383 corresponding to color components of C (cyan), M (magenta), Y (yellow), and K (black). The image forming section 38 further includes a transfer body 384, secondary transfer rollers 385, and an image fixing section 39.

The exposure section 381 includes a laser diode (LD) as a light emitting element. The exposure section 381 drives the LD, based on image data, and irradiates and exposes the charged photosensitive drum 382 with laser light to form an electrostatic latent image on the photosensitive drum 382. The developing section 383 develops the electrostatic latent image formed on the photosensitive drum 382 by supplying toner (color material) of a predetermined color (one of C, M, Y, and K) onto the exposed photosensitive drum 382 with a charged developing roller.

The images (single-color images) formed with the toners of C, M, Y, and K on the four photosensitive drum 382 corresponding to C, M, Y, and K are sequentially transferred and superimposed onto the transfer body 384 from the photosensitive drum 382. Thus, a color image having color components of C, M, Y, and K is formed on the transfer body 384. The transfer body 384 is an endless belt wound around transfer-body conveyance rollers. The transfer body 384 is rotated by the rotation of the transfer body conveyance rollers.

The secondary transfer rollers 385 transfer the color image on the transfer body 384 onto a sheet fed from the sheet feed device 10. Specifically, a pair of secondary transfer rollers 385 forms a transfer nip portion by being pressed against each other and, at the transfer nip portion, nips the sheet and the transfer body 384. Then, a predetermined transfer current is supplied to the secondary transfer roller 385, so that the toner that forms the color image on the transfer member 384 is attracted and transferred to the sheet.

The image fixing section 39 includes fixing rollers and pressure rollers. The image fixing section 39 performs a fixing process of fixing toner to the sheet by heating and pressing the sheet to which the toner has been transferred.

The conveyance section 40 includes sheet conveyance rollers that convey the sheet by rotating while nipping the sheet. The conveyance section 40) conveys the sheet on a predetermined conveyance route.

The conveyance section 40 includes a reversing mechanism 401 that turns over the sheet subjected to the fixing processing by the image fixing section 39 and conveys the sheet to the secondary transfer roller 385. In forming images on both surfaces of a sheet in the image forming apparatus 30, the sheet is reversed by the reversing mechanism 401; images are formed on both surfaces of the sheet; and the sheet is ejected (output). In forming an image on only one side of a sheet, the sheet having an image formed on one side is ejected (output) without being turned over by the reversing mechanism 401.

The temperature and humidity sensor 41 detects temperature and humidity in the image forming apparatus 30 and outputs temperature and humidity information (environmental information) as a detection result to the controller 31.

In the present embodiment, the controller 31 of the image forming apparatus 30 centrally controls the entire image forming system 100, but the present invention is not limited thereto. The detection controller 21 of the detection device 20 may centrally control the entire image forming system 100.

### (2. Operation of Image Forming System)

Next, sample image outputting operations by the image forming system 100 will be described.

First, the user stores sheets to be used for outputting sample images and job-based images in the sheet feed trays of the sheet feed section 13. Next, on a non-illustrated sheet setting screen, the user manipulates the operation part 33 (input receiver) to input the sheet characteristic information, such as the sheet type, sheet size, and basis weight of the stored sheets in association with the sheet feed tray in which the sheets have been stored. The user also manipulates the operation part 33 to determine the sheet feed tray in which the sheets have been stored to be a sheet feed tray that is used for outputting sample images and job-based images.

The controller 31 obtains information of the sheet feed tray and the sheet characteristic information input by the manipulation of the operation part 33, and stores the information in the RAM or the storage section 32.

Next, the user manipulates the operation part 33 to instruct output of sample images (output of samples). For example, pressing an “output sample” button displayed on the display part 34 gives an instruction to output sample images. When receiving the instruction to output sample images by the manipulation of the operation part 33, the controller 31 executes the sample image outputting process.

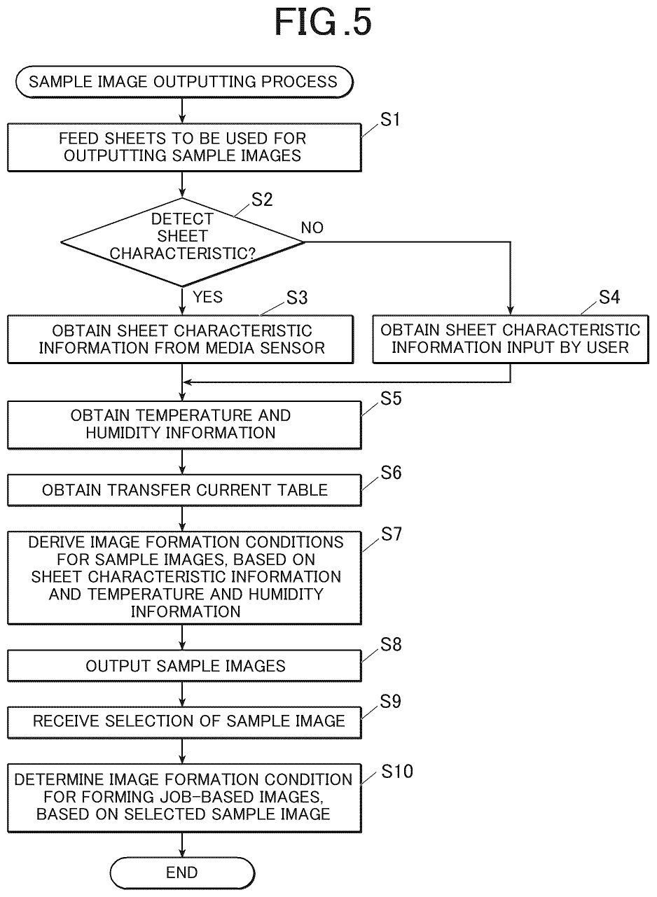

FIG. 5 is a flowchart illustrating a flow of the sample image outputting process. The sample image outputting process is executed by the CPU of the controller 31 in accordance with the program stored in the ROM.

First, the controller 31 causes the sheet feed device 10 to feed a sheet to be used for outputting sample images from the sheet feed section 13 and causes the conveyance sections 12, 22, and 40 to convey the sheet (step S1).

Next, the controller 31 determines whether the media sensor 23 of the detection device 20 has detected a sheet characteristic (step S2).

The controller 31 determines whether the media sensor 23 has detected a sheet characteristic, based on whether the sheet characteristic information has been input by the detection device 20. Herein, if the media sensor 23 is not working or if the detection device 20 is not provided, the media sensor 23 does not detect the sheet characteristic.

When determining that the sheet characteristic has been detected by the media sensor 23 (step S2: YES), the controller 31 obtains the sheet characteristic information input from the media sensor 23 (step S3) and proceeds to step S5. On the other hand, when determining that the sheet characteristic has not been detected by the media sensor 23 (step S2: NO), the controller 31 obtains the sheet characteristic information input by the user's manipulation of the operation part 33 from the RAM or the storage section 32 (step S4) and proceeds to step S5.

In step S5, the controller 31 obtains temperature and humidity information (environment information) from the temperature and humidity sensor 41 (step S5).

Next, the controller 31 obtains the transfer current table from the storage section 32 (step S6). When the sheet characteristic information is input from the media sensor 23, the controller 31 obtains the transfer current table 322 from the storage section 32. When the sheet characteristic information is not input from the media sensor 23, the controller 31 obtains the transfer current table 321 from the storage section 32.

Next, the controller 31 refers to the obtained transfer current table and derives image formation conditions for outputting sample images, based on the obtained sheet characteristic information and environment information (step S7).

As described above, the transfer current tables 321 and 322 each store (i) combinations of sheet characteristic information and environment information and (ii) image formation conditions (transfer currents) corresponding to the respective combinations under which sample images (samples 1 to 5) are output. These (i) and (ii) are stored in association with each other. In the transfer current tables 321 and 322, the range of the image formation condition associated with each combination of the sheet characteristic information and the environment information is the range that does not cause image defects under that combination.

Herein, as shown in FIG. 3 and FIG. 4, with the same environmental information (humidity), the range of image formation conditions (transfer currents) for all the sample images set for the coated paper is narrower than that for the plain paper; and the interval between image formation conditions for the sample images set for the coated paper is narrower than that for the plain paper. This is because the range of transfer currents that do not cause image defects is narrower for the coated paper than the plain paper. Similarly, with the same environmental information (humidity), the range of image formation conditions (transfer currents) for all the sample images set for the color paper is narrower than that for the plain paper; and the interval of image formation conditions between the sample images for the color paper is narrower than that for the plain paper. This is because the range of transfer currents that do not cause image defects is narrower for the color paper than for the plain paper. Further, the lower the humidity is, the narrower the range of image formation conditions (transfer currents) for all the sample images is, and the narrower the interval of image formation conditions between the sample images is. This is because the lower the humidity is, the narrower the range of transfer currents that do not cause image defects is.

The controller 31 refers to the obtained transfer current table and derives the image formation conditions for samples 1 to 5 associated with the obtained sheet characteristic information and environment information as the image formation conditions for outputting the sample images. For example, when the sheets are coated paper, the controller 31 refers to the obtained transfer current table and derives the image formation conditions for the respective sample images such that a difference (change) between the image forming conditions for the sample images is smaller than when the sheets are plain paper. When the sheets are color paper, the controller 31 refers to the obtained transfer current table and derives the image formation conditions for the respective sample images such that a difference (change) between the image forming conditions for the sample images is smaller than when the sheets are plain paper. Further, the controller 31 refers to the obtained transfer current table and derives the image formation conditions for the respective sample images such that a difference (change) between the image formation conditions for the sample images becomes smaller (greater) as the humidity becomes lower (higher). Thus, appropriate sample images having no image defect can be output.

The lower the print coverage of sample images is, the less visible the difference in output images due to different image formation conditions is, and the less visible an image defect is. To deal with this, the transfer tables as shown in FIG. 3 and FIG. 4 may be prepared for each coverage and stored in the storage section 32, for example. The controller 31 may refer to the transfer table for each coverage and change the setting range and the setting interval of image formation conditions for sample images according to the coverage of the sample images in addition to the sheet characteristic information and the environment information. Specifically, the controller 31 may increase the setting range and the setting interval for sample images having a lower coverage. Thus, appropriate sample images corresponding to the coverage can be output.

The sample image may be a predetermined image stored in the storage section 32 beforehand, an arbitrary image specified by the user, or both of the predetermined image and the arbitrary image.

Next, the controller 31 causes the image forming section 38 to form and output sample images on the sheet(s) under the derived different image formation conditions (step S8).

The controller 31 controls the sheet feed section 13, the conveyance sections 12, 22, and 40, the image forming section 38, and so forth to change the image formation conditions while outputting the sample images in step S8. Thus, the controller 31 outputs multiple sample images onto the sheet(s). For example, the controller 31 changes the image formation conditions in the order from the derived image formation condition for the sample 1, the image formation condition for the sample 2, the image formation condition for the sample, 3, the image formation condition for the sample 4, to the image formation condition for the sample 5, and thus forms and outputs multiple sample images on the sheet with the image forming section 38. The sample images may be output on different sheets or on a single sheet. When the sample images are formed on one sheet, an image defect may be more likely to occur on a certain part of the sheet. It is therefore preferable that the sample images under different image formation conditions be formed on different sheets.

Each of the output sample images is printed in association with the corresponding identification number.

Next, the controller 31 receives selection of an optimal sample image by the user (step S9).

For example, the controller 31 displays, on the display part 34, a message such as “select the best sample image” and a selection screen (input screen) that shows the identification numbers of the respective sample images as options, and receives selection of a sample image by the user.

The controller 31 determines an image formation condition used for forming the selected sample image as the image formation condition to be used for forming job-based images on sheets (step S10) and ends the sample image outputting process.

As described above, in the image forming system 100, the controller 31 of the image forming apparatus 30 changes image formation conditions while outputting sample images, based on the sheet characteristic information and the environment information. Since the sample images are output under different image formation conditions according to the sheet characteristic information and the environment information, appropriate sample images can be output regardless of the sheet characteristic and the environment.

For example, the controller 31 outputs multiple sample images under different image formation conditions, based on the sheet characteristic information and the environment information. Since multiple sample images are output under different image formation conditions according to the sheet characteristic information and the environment information, appropriate sample images can be output regardless of the sheet characteristic and the environment.

The sheet characteristic information can be obtained via the input receiver (operation part 32) with which the user inputs the sheet characteristic information. Further, the sheet characteristics can be obtained from the media sensor 23 that detects the characteristics of sheets. Thus, more accurate sheet characteristic information can be obtained.

Further, the controller 31 changes the range of image formation conditions for the entire sample images, based on the sheet characteristic information and the environment information. Thus, the range of image formation conditions for the entire sample images can be changed according to the sheet characteristic and the environment. Further, the controller 31 changes an interval between image formation conditions among the sample images, based on the sheet characteristic information and the environment information. Thus, the interval between image formation conditions for the sample images can be changed according to the sheet characteristic and the environment.

Further, the controller 31 outputs the sample images under different image formation conditions onto different sheets. Therefore, even if an image defect is more likely to occur in a specific part of the sheet, the user can appropriately compare and check the sample images.

Further, the image forming apparatus 30 includes the temperature and humidity sensor 41. The controller 31 increases a difference between image formation conditions (transfer currents) for the sample images, as the humidity obtained from the temperature and humidity sensor 41 increases. Since the image formation conditions for the sample images are changed according to the humidity, appropriate sample images can be obtained regardless of the humidity.

Further, the controller 31 determines an image formation condition for the image forming section 38 to form a job-based image, based on the sample image selected by the user from the output sample images. Thus, the image formation conditions corresponding to the user's request can be determined as the image formation condition for forming job-based images.

Further, at least either an arbitrary image or a predetermined image is used as sample images. Therefore, sample images can be determined based on the user's request.

Further, the controller 31 changes either the range of image formation conditions for the entire sample images or the interval between image formation conditions for the sample images according to the coverage of the sample images. Therefore, appropriate sample images corresponding to the coverage can be output.

Further, when the sheet is coated paper, the controller 31 determines the image formation conditions such that a difference between the image formation conditions for the sample images is smaller than that when the sheet is plain paper. Therefore, appropriate sample images can be output according to the sheet type.

Further, when the sheet is color paper, the controller 31 determines the image formation conditions such that a difference between the image formation conditions for the sample images is smaller than that when the sheet is plain paper. Thus, appropriate sample images can be output according to the sheet type.

The above embodiment is a suitable example of the embodiment according to the present disclosure and is not intended to limit the present disclosure.

For example, although the image forming system 100 in the above embodiment includes both the media sensor 23 that obtains sheet characteristic information and the temperature and humidity sensor 41 that obtains environment information, the image forming system 100 may include only either of them.

For example, when the image forming system 100 does not include a means for obtaining environment information, the controller 31 may not use the environment information. The controller 31 may change the image formation conditions while outputting the sample images, based on the sheet characteristic information. For example, the storage section 32 stores a table in which the sheet characteristic information is associated with multiple image formation conditions (transfer currents) for outputting sample images (samples 1 to 5) using the sheet corresponding to the sheet characteristic information. In this table, the range of image formation conditions for sample images is set such that no image defect occurs even at low temperature or low humidity (e.g., humidity lower than 35%). Based on this table, the controller 31 derives image formation conditions for the respective sample images.

For another example, when the image forming system 100 does not include a means for obtaining the sheet characteristic information, the controller 31 may change the image formation conditions while outputting the sample images, based on the environment information without using the sheet characteristic information. For example, the storage section 32 stores a table in which the environment information is associated with multiple image formation conditions (transfer currents) for outputting sample images (samples 1 to 5) under the environmental condition. In this table, the range of image formation conditions for sample images is set such that no image defect occurs even with coated paper. Based on this table, the controller 31 determines the image formation conditions for the respective sample images.

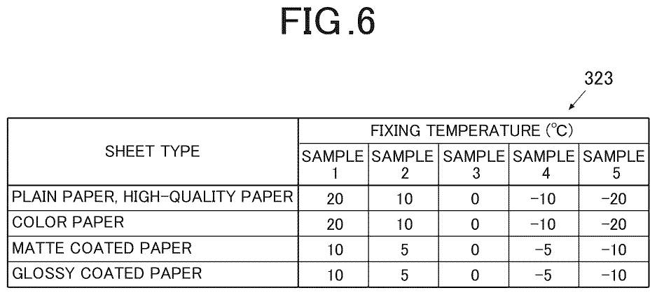

In the above embodiment, the image formation conditions to be changed during the output of the sample images are the transfer currents, as an example. However, the image formation conditions to be changed are not limited to the transfer currents. The image formation conditions to be changed during the output of the sample images may be the fixing temperatures, for example. FIG. 6 is an example of how the data of a fixing temperature table 323 is stored. The controller 31 refers to the fixing temperature table 323 to determine image formation conditions of sample images in a case where the image formation conditions to be changed during output of the sample images are fixing temperatures. As shown in FIG. 6, the fixing temperature table 323 stores sheet characteristic information in association with the fixing temperatures for fixing sample images when the sample images are output to sheets corresponding to the sheet characteristic information. The fixing temperatures in the fixing temperature table 323 each represent a difference from a default fixing temperature. The fixing temperature table 323 is created, based on the experimentally obtained ranges of fixing temperatures in which changes in glossiness are acceptable for the respective pieces of sheet characteristic information (the respective sheet types). That is, in the fixing temperature table 323, for each sheet type, the range of fixing temperatures in which changes in glossiness are acceptable is determined to be the setting range of fixing temperatures for outputting sample images. Based on the setting range and the number of sample images, the interval between the fixing temperatures for the sample images is obtained, and the fixing temperature for each sample image is determined. Herein, changes in glossiness due to fixing temperatures are greater for coated paper than for plain paper, high-quality paper, and color paper. Therefore, as shown in FIG. 6, the setting range of fixing temperatures for sample images set for coated paper is lower than for plain paper, high-quality paper, and the color paper.

Although in FIG. 6 the sheet characteristic information is a sheet type, the storage section 32 also stores a table in which the sheet characteristic information is information on physical properties of sheets obtained by the media sensor 23, similarly to the transfer current table 322 of FIG. 4.

The controller 31 refers to the fixing temperature table stored in the storage section 32 and derives fixing temperatures to be changed while outputting the sample images, based on the obtained sheet characteristic information. When the sheet type is coated paper, the controller 31 determines the fixing temperatures such that a difference between fixing temperatures for sample images is smaller than when the paper type is plain paper, high-quality paper, or color paper. Thus, appropriate sample images can be output regardless of the sheet characteristic. The controller 31 may change both the transfer current and the fixing temperature while outputting the sample images.

In the above-described embodiment, the controller 31 of the image forming apparatus 30 functions as the hardware processor of the present disclosure as an example. However, the function of the hardware processor of the present disclosure may be separate from the image forming apparatus 30. For example, the function of the hardware processor of the present disclosure may be provided to a control device that controls the image forming apparatus 30 but that is provided separately from the image forming apparatus 30 in the image forming system 100.

In the above-described embodiment, the sheet feed device 10 and the detection device 20 are separate from the image forming apparatus 30 as an example. However, the sheet feed tray and/or the media sensor may be provided in the image forming apparatus.

In the above-described embodiment, the present disclosure is applied to an electrophotographic image forming apparatus as an example. However, the present disclosure is not limited thereto and is also applicable to an image forming apparatus using the inkjet method of or any other printing method.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image former that forms and outputs an image on a sheet; and
a hardware processor that causes the image former to output a sample image on the sheet;
wherein the hardware processor changes an image formation condition while the image former is outputting the sample image, based on at least one of sheet characteristic information and environment information.

2. The image forming apparatus according to claim 1, wherein the hardware processor causes the image former to output multiple sample images under different image formation conditions.

3. The image forming apparatus according to claim 1, wherein the hardware processor obtains the sheet characteristic information from a media sensor that detects a characteristic of the sheet.

4. The image forming apparatus according to claim 1, wherein the hardware processor obtains the sheet characteristic information input by a user via an input receiver.

5. The image forming apparatus according to claim 2, wherein the hardware processor changes a setting range of the image formation conditions for all the sample images, based on at least one of the sheet characteristic information and the environment information.

6. The image forming apparatus according to claim 2, wherein the hardware processor changes a setting interval between the image formation conditions for the sample images, based on at least one of the sheet characteristic information and the environment information.

7. The image forming apparatus according to claim 1, wherein the image formation condition includes at least one of a transfer condition and a fixing condition.

8. The image forming apparatus according to claim 1, wherein the hardware processor causes the image former to output sample images under different image formation conditions onto different sheets.

9. The image forming apparatus according to claim 1, further comprising a sensor that measures at least humidity in the image forming apparatus, wherein the hardware processor obtains the environment information from the sensor.

10. The image forming apparatus according to claim 9, wherein when multiple sample images are output under different image formation conditions, the hardware processor determines the image formation conditions such that the higher the humidity obtained from the sensor is, the greater a difference is between the different image formation conditions for the sample images.

11. The image forming apparatus according to claim 2, wherein, based on a sample image selected by a user from the output sample images, the hardware processor determines an image formation condition for forming a job-based image by the image former.

12. The image forming apparatus according to claim 1, wherein the sample image is at least one of an arbitrary image and a predetermined image.

13. The image forming apparatus according to claim 5, wherein the hardware processor changes either the setting range of the image formation conditions for all the sample images or a setting interval between the image formation conditions for the sample images, according to a coverage of the sample images.

14. The image forming apparatus according to claim 2, wherein when the sheet is coated paper, the hardware processor determines the image formation conditions such that a difference between the image formation conditions for the sample images is smaller than when the sheet is plain paper.

15. The image forming apparatus according to claim 2, wherein when the sheet is color paper, the hardware processor determines the image formation conditions such that a difference between the image formation conditions for the sample images is smaller than when the sheet is plain paper.

16. An image forming system comprising:
an image former that forms and outputs an image on a sheet; and
a hardware processor that causes the image former to output a sample image on the sheet, wherein
the hardware processor changes an image formation condition while the image former is outputting the sample image, based on at least one of sheet characteristic information and environment information.

17. A non-transitory computer-readable storage medium storing a program that causes a computer to:
cause an image former that forms and outputs an image on a sheet to output a sample image on the sheet, and
change an image formation condition while the image former is outputting the sample image, based on at least one of sheet characteristic information and environment information.
